(19) United States
(12) Patent Application Publication
(10) Pub. No.: US 2023/0157383 A1
(43) Pub. Date: May 25, 2023

(54) HEATING ELEMENTS FOR HEATED GEAR

(71) Applicant: MILWAUKEE ELECTRIC TOOL CORPORATION, Brookfield, WI (US)

(72) Inventor: Zachary Self, Nashotah, WI (US)

(21) Appl. No.: 17/988,382

(22) Filed: Nov. 16, 2022

Related U.S. Application Data
(60) Provisional application No. 63/281,455, filed on Nov. 19, 2021.

(51) Int. Cl. A41D 13/005; H05B 1/02

(52) U.S. Cl. CPC A41D 13/0051; H05B 1/0272; H05B 2203/036; A41D 1/005

(57) ABSTRACT

A heated garment including a garment body, a heater array supported by the garment body, and a power supply interface. The heater array includes a heating wire that forms a closed loop, the closed loop defining a shape having a plurality of cantilevered fingers. The power supply interface is configured to couple to a power source that provides power to the heater array.

### CROSS-REFERENCE TO RELATED APPLICATIONS

This application claims priority to co-pending U.S. Provisional Patent Application No. 63/281,455, filed Nov. 19, 2021, the entire content of which is incorporated herein by reference.

### FIELD

The present application relates to heated garments and, in particular, heating elements for heated garments

### SUMMARY

Heated garments include heating elements to produce heat that warms a wearer of the heated garment. For example, heating elements may include heater arrays that use carbon fiber heaters, conductive ink fabrics, and/or thermoelectric heating/cooling devices, among other things. Heating elements may be small and sparsely located throughout the heated garment, reducing the overall cost of the heating elements. For example, small heaters may be positioned at positions in the front and back of the heated garment, along flat surfaces.

The present disclosure provides, among other things, carbon fiber heating elements with increased heat and/or stretchability for heated garments. For example, carbon fiber heating elements may include cuts in the fabric that allow increased stretch in the heating element for more fluid movement in a heated garment. Additionally, the present disclosure provides, among other things, conductive ink heating elements for heated garments. For example, conductive ink heating elements may be positioned at locations on the heated garment that could traditionally not accommodate a heating device. Additionally, the present disclosure provides, among other things, phase change material, heat shields, and heating fabric for increased heat retention in heated garments. Additionally, the present disclosure provides, among other things, a thermoelectric cooler/heater device for heating and cooling heated garments.

Embodiments described herein provide a heated garment. The heated garment includes a garment body, a heater array supported by the garment body, and a power supply interface. The heater array includes a heating wire that forms a closed loop, the closed loop defining a shape having a plurality of cantilevered fingers. The power supply interface is configured to couple to a power source that provides power to the heater array.

Further embodiments described herein provide a heated garment. The heated garment includes a garment body, a heater array supported by the garment body, and a power supply interface. The heater array includes a stretchable fabric layer and a heating wire positioned on the stretchable fabric layer. The power supply interface is configured to couple to a power source that provides power to the heater array.

Further embodiments described herein provide a heated garment. The heated garment includes a garment body, a heater array supported by the garment body, and a power supply interface. The heater array includes a stretchable fabric layer and a heating wire positioned on the stretchable fabric layer, the heating wire forming a closed loop. The power supply interface is configured to couple to a battery pack that provides power to the heater array.

Further embodiments described herein provide a heated garment. The heated garment includes a jacket body, a heater array supported by the garment body, and a power supply interface. The jacket body includes a torso region, a left sleeve connected to the torso region, a right sleeve connected to the torso region, a left armpit region positioned between the left sleeve and the torso region, and a right armpit region positioned between the right sleeve and the torso region. The heater array is positioned in the left armpit region, the right armpit region, or both armpit regions. The power supply interface is configured to couple to a power source that provides power to the heater array.

Further embodiments described herein provide a heated garment. The heated garment includes a garment body, a conductive ink heater array supported by the garment body, and a power supply interface. The garment body is configured to be worn on one selected from a group consisting of a user's arms, a user's feet, a user's hands, and a user's head. The power supply interface is configured to couple to a power source that provides power to the conductive ink heater array.

Further embodiments described herein provide a heated garment. The heated garment includes a garment body, a heater array supported by the garment body, and a power supply interface. The heater array includes a first heater and a second heater. The power supply interface is configured to couple to a power source that provides power to the heater array.

Further embodiments described herein provide a heated garment. The heated garment includes a garment body, a heater array supported by the garment body, and a power supply interface. The garment body includes a phase change material layer. The power supply interface is configured to couple to a power source that provides power to the heater array.

Further embodiments described herein provide a heated garment. The heated garment includes a garment body, a heater array supported by the garment body, and a power supply interface. The garment body includes an insulative material. The heater array is positioned adjacent to the insulative material. The power supply interface is configured to couple to a power source that provides power to the heater array.

Further embodiments described herein provide a heated garment. The heated garment includes a garment body, a thermoelectric cooling and heating device positioned on the garment body, and a power supply interface. The power supply interface is configured to couple to a power source that provides power to the thermoelectric cooling and heating device.

Other aspects of the invention will become apparent by consideration of the detailed description and accompanying drawings.

### BRIEF DESCRIPTION OF THE DRAWINGS

FIG. 1A illustrates a front view of a heated garment, according to some embodiments.

FIG. 1B illustrates a back view of the heated garment of FIG. 1A, according to some embodiments.

FIG. 2 illustrates a front view of a heated garment, according to some embodiments.

FIG. 3 illustrates a schematic of a controller for the heated garments of FIGS. 1A and 2.

FIGS. 4A-4G illustrate carbon fiber heaters for the heated garments of FIGS. 1A and 2, according to some embodiments.

FIG. 5 illustrates a conductive ink heater for the heated garments of FIGS. 1A and 2, according to some embodiments.

FIGS. 6A-6G illustrate possible heater locations for the heated garments of FIGS. 1A and 2, according to some embodiments.

FIG. 7 illustrates another conductive ink heater for the heated garments of FIGS. 1A and 2, according to some embodiments.

FIG. 8 illustrates a heated accessory, according to some embodiments.

FIG. 9 illustrates a heated accessory, according to some embodiments.

FIG. 10 illustrates a heat shield for the heated garments of FIGS. 1A and 2, according to some embodiments.

FIGS. 11A and 11B are infrared diagrams illustrating the effect of the heat shield of FIG. 10, according to some embodiments.

FIG. 12 illustrates a back view of a heated garment, according to some embodiments.

FIG. 13 illustrates a thermoelectric heating and cooling device for the heated garment of FIG. 12, according to some embodiments.

FIG. 14 illustrates a heated fabric, according to some embodiments.

FIG. 15 schematically illustrates a phase change material, according to some embodiments.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

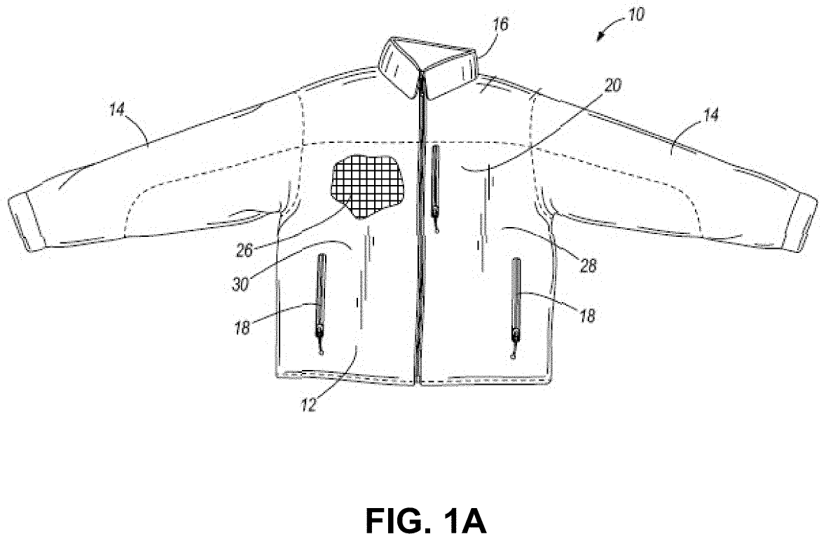

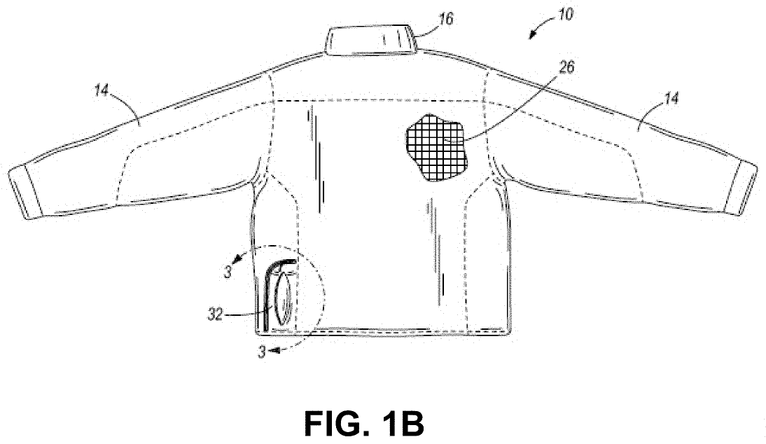

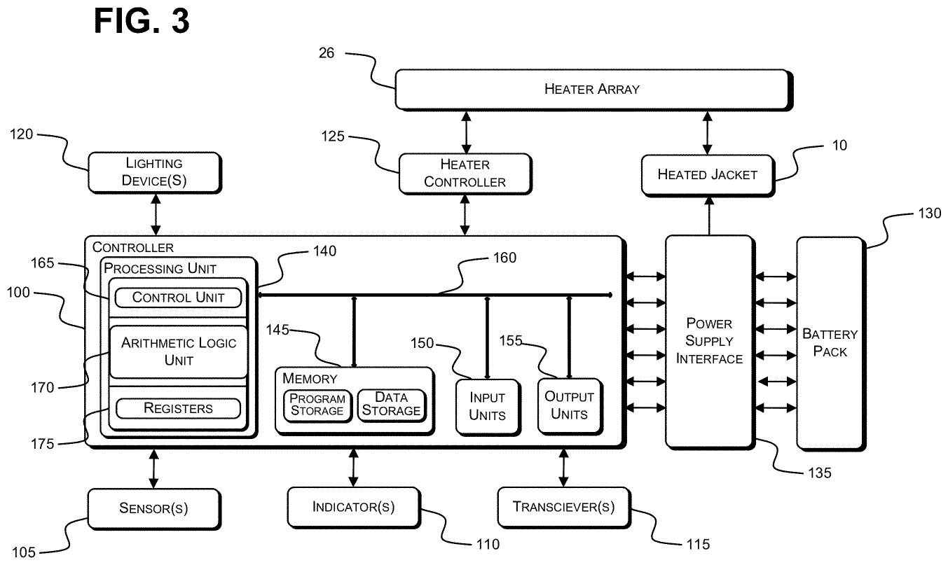

FIG. 1A illustrates a heated garment 10, according to some embodiments. The illustrated heated garment 10 is a heated jacket, however, other garments such as shirts, vests, pants, leggings, overalls, gloves, hats, and shoes or boots may be contemplated. The jacket 10 may be constructed in various sizes to fit a variety of users. The heated jacket 10 includes typical jacket features such as a torso body 12, arms 14, a collar 16, and front pockets 18 located on a chest area 20. As illustrated in cutaway portions of FIGS. 1A and 1B, the heated jacket 10 includes a heater array 26. The heater array 26 is disposed in both a left portion 28 and a right portion 30 of the torso body 12. In some embodiments, the heater array 26 may extend into the arms 14 and/or collar 16. The heater array 26 may be configured to generate heat based on a received DC voltage from a battery pack, for example battery pack 130 (FIG. 3). For example, the heater array 26 may be a resistive heater array, a carbon fiber heater, and/or a conductive ink heater. However, other heater array types are also contemplated. In other embodiments, the heated jacket 10 may include a first heater array and second heater array arranged as an upper module and a lower module, respectively. In some embodiments, the heater array 26 is controlled by the battery pack 130 based on input from an external device. In other embodiments, multiple heater arrays may be controlled individually via a single control input or multiple control inputs. For example, the multiple heater arrays may be isolated and controlled by the battery pack 130 based on input from the device. The heater array 26 may include resistive heating coils formed of carbon fibers, high density carbon fibers, or other heating devices. The heated jacket 10 is capable of maintaining a temperature of up to 110 degrees Fahrenheit, although in other embodiments, lower or greater temperatures are possible depending upon the heat source.

In some embodiments, the heater array 26 may include a negative temperature coefficient thermistor (NTC) or a positive temperature coefficient thermistor (PTC) to determine temperature. For example, the NTC or PTC would be added to the heater array to determine the heater temperature. In some embodiments where a carbon fiber heater is implemented in the heated garment, an NTC or PTC may be required. The NTC or PTC may be added to the heater on or close to the carbon fiber element and the garment ambient. In some embodiments where a conductive ink heater is implemented in a heated garment, the current required to provide heat to the heater array may be determined by a current sensor. For example, a PTC heater may be used such that the current automatically reduces as the temperature of the heater increases based on feedback from the current sensor.

As illustrated in cutout 3-3 of FIG. 1B, the heated jacket 10 includes a compartment 32 located on a lower portion of the back torso body. The compartment 32 houses an electrical component, such as a battery pack 130, and battery holder that holds the battery pack 130. The heated jacket 10 includes a connection port for connecting to the battery pack 130. The battery pack 130 may be a rechargeable battery pack, such as a power tool battery pack. The battery pack 130 may have a Li-ion chemistry or other suitable chemistries. In some embodiments, the battery pack 130 may have a nominal voltage of 9 volts, 12 volts, or 18 volts. In other embodiments, the battery pack 130 may have other voltages.

In some embodiments, the heated jacket 10 may include a controller, such as controller 100 (FIG. 3). In some embodiments, the heated jacket 10 may include at least one connection port for connecting to other heated garments. For example, the connection port(s) may be a USB, USB-C, or USB-PD port. The connection port(s) may be located on the torso body 12, arms 14, and/or collar 16 of the heated jacket 10. Garments connected to the heated jacket 10 via the connection port may receive input power from the battery pack 130.

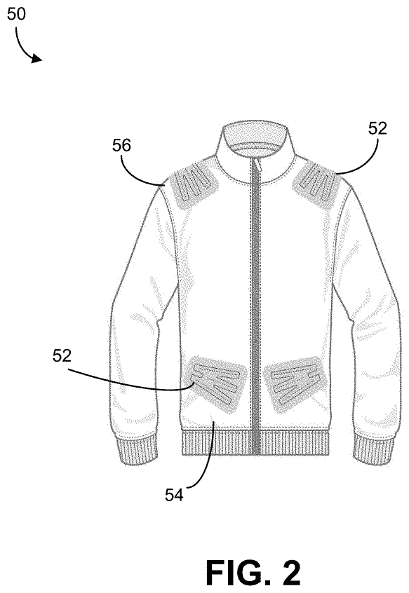

FIG. 2 illustrates another heated jacket 50, according to some embodiments. The heated jacket 50 includes a heater array 52. In some embodiments, the heater array 52 may include similar components and be similarly controlled as the heater array 26 of the heated jacket 10 (FIGS. 1A and 1B). In some embodiments, the heated jacket 50 may include multiple heater arrays 52 that provide a uniform amount of heat to a wearer of the heated jacket 50. Alternatively, in some embodiments, the multiple heater arrays 52 may be separately controlled to provide different levels of heat at various locations. For example, a first heater array 52 may be located on the front 54 of the heated jacket 50, and a second heater array 52 may be located on the shoulder area 56 of the heated jacket. The first heater array 52 may provide a first amount of heat, and the second heater array 52 may provide a second amount of heat that is the same or different than the first amount of heat. In some embodiments, the heater array 52 may be configured to generate heat based on a received DC voltage from a battery pack, for example battery pack 130 (FIG. 3).

A controller 100 for a heated garment (e.g., heated jacket 10, 50) is illustrated in FIG. 3. The controller 100 is electrically and/or communicatively connected to a variety of modules or components of the heated garment. For example, the illustrated controller 100 is connected to sensors 105 (which may include, for example, current sensors, voltage sensors, temperature sensor, etc.), indicators 110, a transceiver(s) 115, lighting device(s) 120, a heater controller 125, and the battery pack 130. In some embodiments, the controller 100 may be included in the battery pack 130 such that the battery pack 130 controls the heated garment.

The controller 100 includes a plurality of electrical and electronic components that provide power, operational control, and protection to the components and modules within the controller 100 and/or heated jacket 10, 50. For example, the controller 100 includes, among other things, a processing unit 140 (e.g., a microprocessor, an electronic processor, an electronic controller, a microcontroller, or another suitable programmable device), a memory 145, input units 150, and output units 155. The processing unit 140 includes, among other things, a control unit 165, an arithmetic logic unit (“ALU”) 170, and a plurality of registers 175 (shown as a group of registers in FIG. 3), and is implemented using one or more computer architectures (e.g., a modified Harvard architecture, a von Neumann architecture, etc.). The processing unit 140, the memory 145, the input units 150, and the output units 155, as well as the various modules connected to the controller 100 are connected by one or more control and/or data buses (e.g., common bus 160). The control and/or data buses are shown generally in FIG. 3 for illustrative purposes. The use of one or more control and/or data buses for the interconnection between and communication among the various modules and components would be known to a person skilled in the art in view of the embodiments described herein.

The memory 145 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 140 is connected to the memory 145 and executes software instruction that are capable of being stored in a RAM of the memory 145 (e.g., during execution), a ROM of the memory 145 (e.g., on a generally permanent basis), or another non-transitory computer readable medium such as another memory or a disc. Software included in the implementation of the battery pack 2 can be stored in the memory 145 of the controller 100. The software includes, for example, firmware, one or more applications, program data, filters, rules, one or more program modules, and other executable instructions. The controller 100 (e.g., the electronic processor 140) is configured to retrieve from the memory 145 and execute, among other things, instructions related to the control processes and methods described herein. In other embodiments, the controller 100 includes additional, fewer, or different components.

The indicators 110 receive control signals from the controller 100 to turn ON and OFF or otherwise convey information based on different states of the battery pack 130. For example, the indicators 110 may display that the heater array 26, 52 is ON, that the battery pack 130 is out of power, etc. The indicators 110 include, for example, one or more light-emitting diodes (LEDs), or a display screen (e.g., an LCD display). The display/indicator(s) 110 may also include additional elements to convey information to a user through audible or tactile outputs (e.g., a speaker). The display/indicator(s) 110 may also be referred to as an output device configured to provide an output to a user.

The transceiver(s) 115 may include a Bluetooth® controller that communicates with a Bluetooth® enabled device, such as the external device. The transceiver(s) 115 may transmit information regarding components of the heated jacket 10, 50, a status of the heater array 26, 52, information about the heated jacket 10, 50, and/or a status of the battery pack 130. For example, the transceiver(s) 115 may transmit information such as the temperature of the heated jacket 10, 50, a type of heated garment coupled to the heated jacket 10, 50, heating zones, and/or preset information to the device by communicating with a Bluetooth® controller of the device. The transceiver(s) 115 may receive control signals from the external device. For example, the control signals may include temperature set points, heating zones to activate/deactivate, and heater array runtime. In some embodiments, the transceiver(s) 115 communicates with the external device employing the Bluetooth® protocol. Therefore, in some embodiments, the external device and the heated jacket 10, 50 are within a communication range (i.e., in proximity) of each other while they exchange information.

A power supply interface 135 is connected to the controller 100 and couples to the heated garment(s) (e.g., heated jacket 10, 50). The power supply interface 135 includes a combination of mechanical (e.g., an interface portion) and electrical components configured to and operable for interfacing (e.g., mechanically, electrically, and communicatively connecting) the battery pack 130 with the heated jacket 10, 50. The power supply interface 135 transmits the power from the battery pack 130 to the heated jacket 10, 50. The power supply interface 135 includes active and/or passive components (e.g., voltage step-down controllers, voltage converters, rectifiers, filters, etc.) to regulate or control the power transmitted to the heated jacket 10, 50.

The controller 100 may dynamically adjust the heating level of a heated garment that is connected to the controller 100 via the power supply interface. For example, based on an input received from the external device via the transceiver(s) 115 (e.g., a requested runtime of the heater array 26, 52 in the heated jacket 10, 50) and the amount of power left in the battery pack 130, the controller 100 may adjust the heating level of the heater array 26 to be able to operate the heater array for the requested runtime. In the case that a heated garment is coupled to the heated jacket 10, 50, the controller 100 may further dynamically adjust the heating levels of the heater array 26, 52 and the heater array of the heated garment coupled to the heated jacket 10, 50 to be able to operate the heater arrays for the requested runtime.

The controller 100 may also adjust specific heating zones of the heated jacket 10, 50. A user may adjust which heat zones of the heated garment are active on the external device. The device communicates the heating zones that are to be active to the heater controller 125 via the transceiver(s) 115. For example, the user may adjust for various heat settings in different zones. Heat settings may include heating level of the heating zones and the time that the heating zone is active. For example, the heater array located on the front of the heated jacket 10, 50 may be separately controlled from the heater array located on the back of the heated jacket 10, 50. As such, the user may adjust, via the external device, the heating level of the front heater array while maintaining the heating level of the back heater array. The heater controller 125 receives the adjustment by the user via the transceiver(s) 115 and controls the heater arrays accordingly.

In some embodiments, the controller 100 may receive input from a current sensor. The current sensor may receive a signal from the heater array 26 of the heated jacket 10, 50. For example, the current of the heater array 26, 52 may decrease as the temperature of the heater increases. Based on the sensed current and thus the sensed temperature, the temperature of the heaters may be automatically adjusted to a preset temperature. For example, the battery pack 130 will have an extended life in warmer environments since less heat is needed. The controller 100 may adjust the temperature of the heaters based on the ambient temperature and/or the determined temperature of the heater.

In some embodiments, the controller 100 includes a feedback loop that automatically adjusts the temperature of the heated garment without input from a user via the external device. For example, the feedback loop may automatically adjust the heating levels of the heated garment when the heated garment is heated to a predetermined temperature.

In some embodiments, the controller 100 may be able to determine the ambient temperature surrounding the user wearing the heated jacket 10, 50. The ambient temperature may be used by the controller 100 to adjust the temperature settings of the heated garment or to adjust the way the controller 100 reacts. The ambient temperature could be used so that the heated jacket 10, 50 is maintained at a predetermined temperature above the external temperature. The predetermined temperature could be, for example, 10 degrees Fahrenheit, 20 degrees Fahrenheit, and the like.

In some embodiments, the controller 100 may be configured to create bursts of warmth. For example, the controller 100 may be configured to create peaks and valleys in a temperature profile by doing one of varying a duty cycle of a pulse-width modulation (PWM) signal of the heater array 26, 52 or enabling the heater array 26, 52 for a first predetermined time and then disabling the heater array 26, 52 for a second predetermined time. For example, the user wearing the heated garment would feel periods of warmth. Rather than a body becoming adapted to the temperature, the heated garment would create increases in heat which would make the user feel warmer. Human bodies try to maintain a constant temperature by regulating a sweat rate. Creating peaks and valleys in the temperature profile may trick the body into not increasing the sweat rate to cool down.

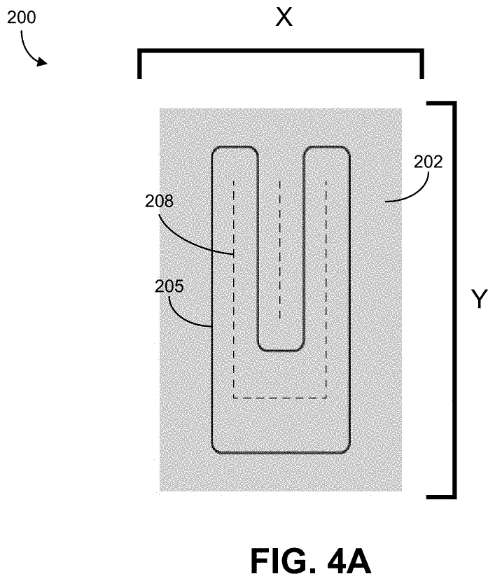

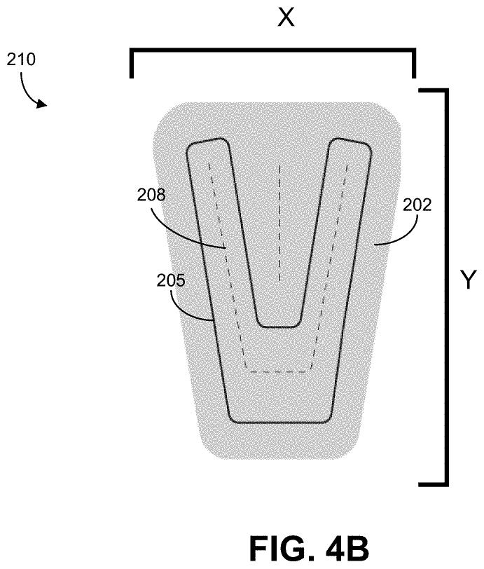

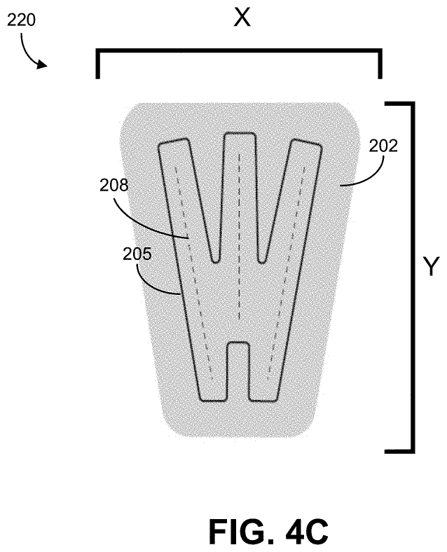

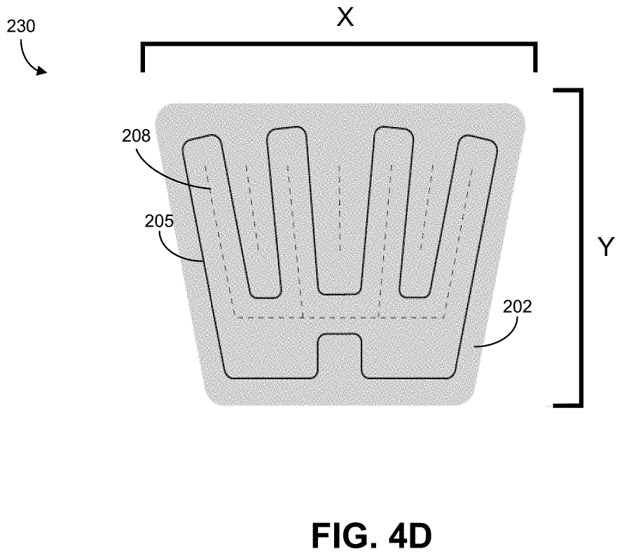

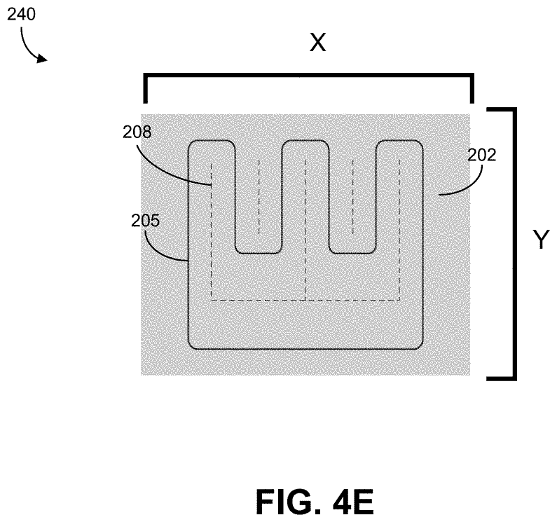

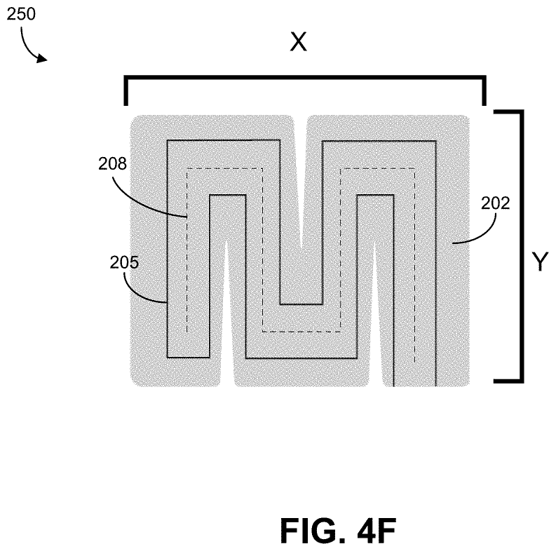

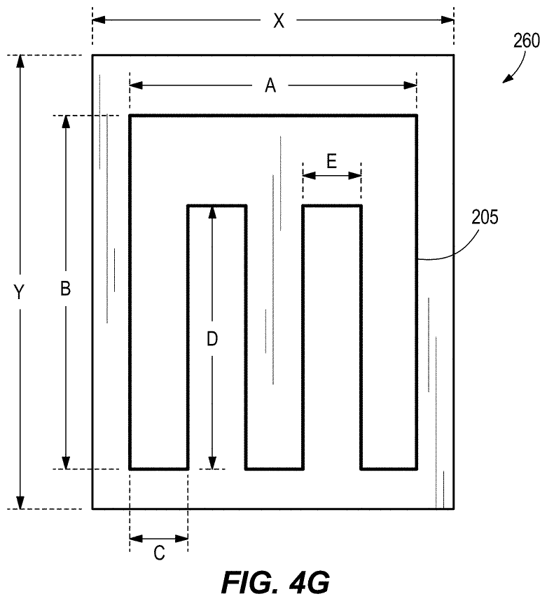

FIGS. 4A-4G illustrate carbon fiber heaters that may be implemented as a heater array (e.g., heater array 26, 52) of heated garments (e.g., heated jackets 10, 50, heated accessories 600, 700 (FIGS. 8 & 9)). In some embodiments, the illustrated carbon fiber heaters may be implemented in other heated garments. The carbon fiber heaters include carbon fiber wiring 205 embedded in fabric 202 that is shaped to provide optimal heating patterns and/or optimal stretchability, thus, providing optimal heat and comfort to the wearer of the heated jacket 10, 50. The carbon fiber wiring 205 may be shaped and connected to itself as a closed loop to provide a “boundary”. The boundary may be embedded into the fabric and form an interior space of the fabric. Cuts in the fabric may be provided in the interior space, as well as outside of the boundary. In some embodiments, the fabric 202 has stretching capabilities. The stretching capabilities may be provided by the cuts in the fabric. Additionally or alternatively, the fabric 202 itself may be stretchable, such as a spandex material. The fabric 202 may be stretchable in two directions or may be stretchable in four directions. In some embodiments, carbon fiber heaters span in an x-direction and a y-direction. For example, the x-direction may be 10-25 centimeters (cm) and the y-direction may be 10-20 cm. In other embodiments, the carbon fiber heaters may be larger or smaller. In some embodiments, the carbon fiber heater may include cantilevered fingers that extend parallel to one another. Additionally, in some embodiments, the carbon fiber heater may include cantilevered fingers that are fanned out from one another.

FIG. 4A illustrates a first carbon fiber heater 200. Carbon fiber wiring 205 is shaped in a first configuration with two right angle protrusions, or cantilevered fingers, in the y-direction with substantially the same widths in the x-direction. The carbon fiber wiring 205 thereby forms a generally U-shaped heating element. A continuous cut 208 in the fabric 202 is located on an interior of the carbon fiber wiring 205. An additional cut 208 is provided in the fabric 202 between the protrusions of the carbon fiber wiring 205.

FIG. 4B illustrates a second carbon fiber heater 210. Carbon fiber wiring 205 is shaped in a second configuration with two protrusions, or cantilevered fingers, in the y-direction fanned out (i.e., obliquely angled) from one another in opposing directions in the x-direction. The carbon fiber wiring 205 thereby forms a generally V-shaped heating element. A continuous cut 208 in the fabric 202 is located on an interior of the carbon fiber wiring 205. An additional cut 208 is provided in the fabric 202 between the protrusions of the carbon fiber wiring 205.

FIG. 4C illustrates a third carbon fiber heater 220. Carbon fiber wiring 205 is shaped in a third configuration with three protrusions, or cantilevered fingers, in the y-direction and a concaved portion in the y-direction opposite the direction of the three protrusions. The concaved portion forms two additional, smaller protrusions, or cantilevered fingers. The two protrusions on the exteriors are fanned out (i.e., obliquely angled) from the center protrusion in opposing directions in the x-direction. The carbon fiber wiring 205 thereby forms a generally W-shaped heating element. Three separate cuts 208 in the fabric 202 are located on an interior of the carbon fiber wiring 205.

FIG. 4D illustrates a fourth carbon fiber heater 230. Carbon fiber wiring 205 is shaped in a fourth configuration with four protrusions, or cantilevered fingers, in the y-direction and a concaved portion in the y-direction opposite the direction of the four protrusions. The first two protrusions in the x-direction are fanned out (i.e., obliquely angled) in an opposite x-direction form the second two protrusions in the x-direction. A continuous cut 208 in the fabric 202 is located on an interior of the carbon fiber wiring 204. Three separate cuts 208 in the fabric 202 are located between the four protrusions.

FIG. 4E illustrates a fifth carbon fiber heater 240. Carbon fiber wiring 205 is shaped in a fifth configuration with three protrusions, or cantilevered fingers, in the y-direction with substantially the same widths in the x-direction. A continuous cut 208 in the fabric 202 is located on an interior of the carbon fiber wiring 205. Two additional cuts 208 are provided in the fabric 202 between the protrusions of the carbon fiber wiring 205.

FIG. 4F illustrates a sixth carbon fiber heater 250. Carbon fiber wiring 205 is shaped in a sixth configuration that is a continuous M-shape starting at a first end and ending at a second end including a connection point. The first end forms a first cantilevered finger, while the second end forms a second cantilevered finger. A continuous cut 208 in the fabric 202 is located in an interior of the carbon fiber wiring 205. The sixth carbon fiber heater design 250 includes cut outs in the fabric 202 for additional stretch.

FIG. 4G illustrates a seventh carbon fiber heater 260. Carbon fiber wiring 205 is shaped in a seventh configuration with three protrusions, or cantilevered fingers, in the y-direction. The carbon fiber wiring is a first width (e.g., “A” in FIG. 4G) and a first height (e.g., “B” in FIG. 4G). The three protrusions are a second width (e.g., “C” in FIG. 4G) and a second height (e.g., “D” in FIG. 4G). The three protrusions are separated from one another by a third width (e.g., “E” in FIG. 4G). “A”, “B”, “C”, “D”, and “E” are 1-20 cm.

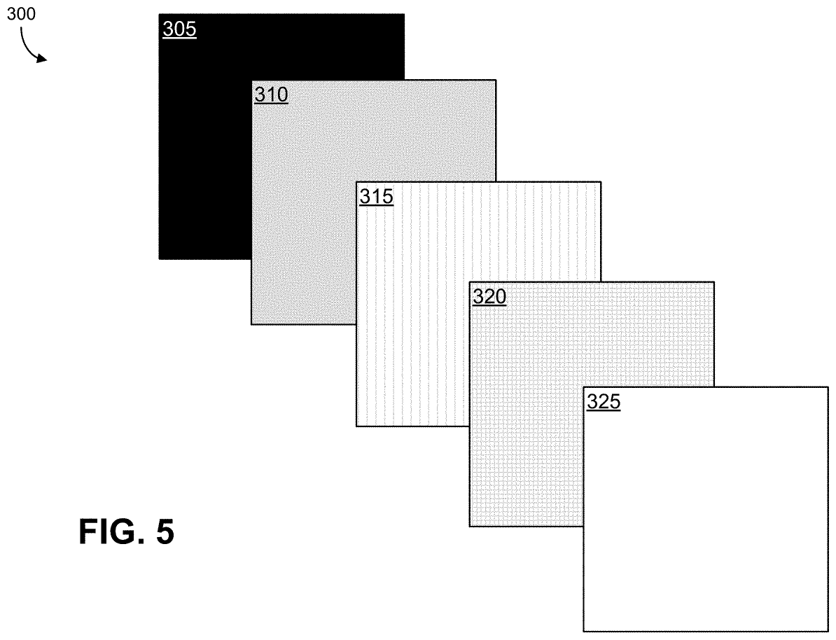

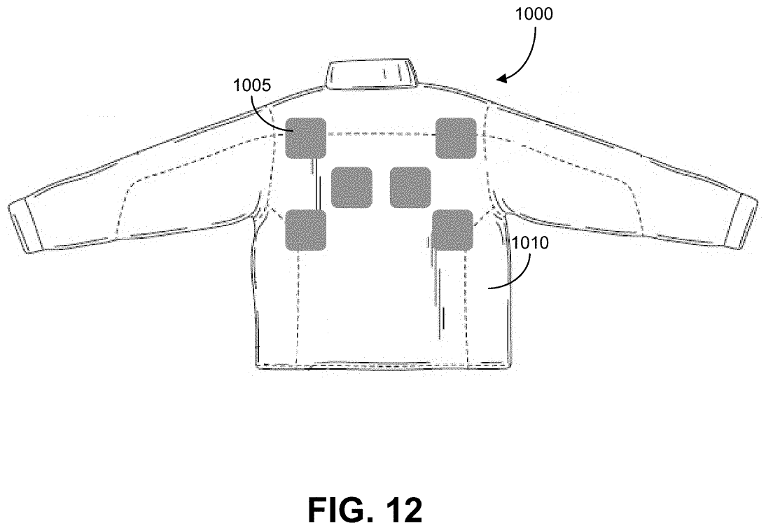

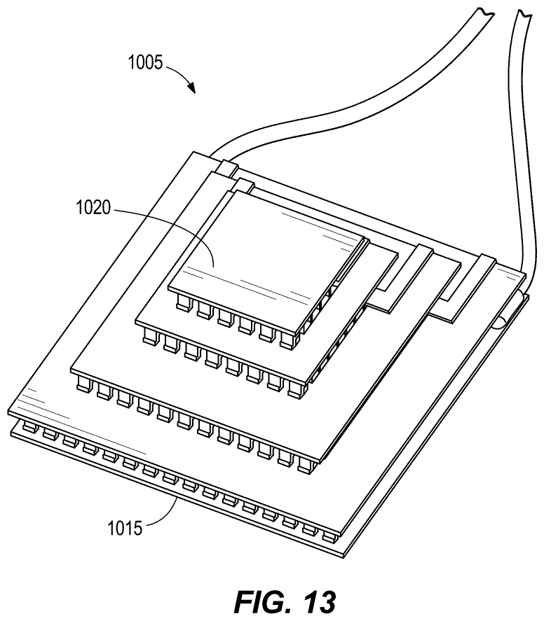

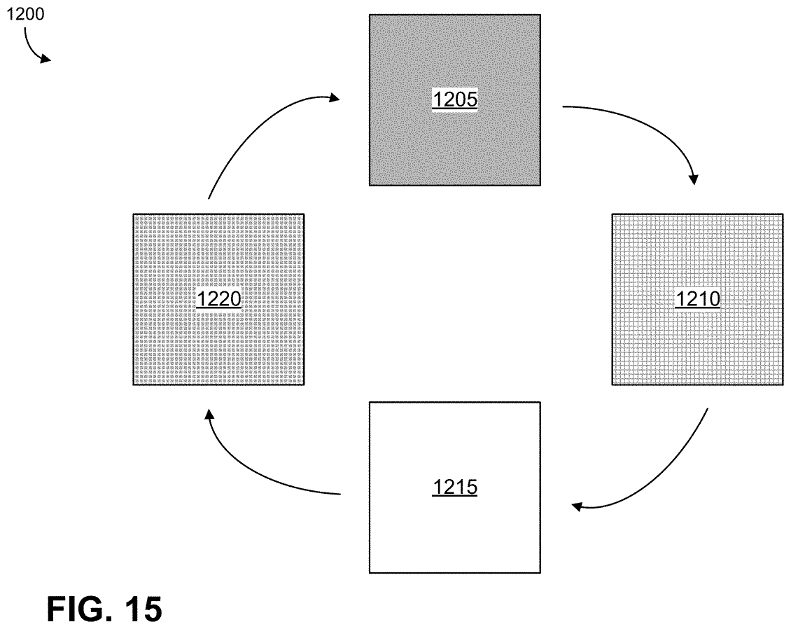

The carbon fiber heaters 200, 210, 220, 230, 240, 250, 260 provide relatively large heating areas in different shapes. As such, the carbon fiber heaters 200, 210, 220, 230, 240, 250, 260 may be suitable for different types of garments or for different locations in the garments. In addition, the cuts 208 allow the carbon fiber heaters 200, 210, 220, 230, 240, 250, 260 to expand or stretch by allowing sections of the heaters to move relative to each other, such that the heaters move or bend with the fabric of the garments. In some embodiments, the heated jacket 10, 50 may include a combination of the carbon fiber heaters 200, 210, 220, 230, 240, 250, 260. In some embodiments, the heated jacket 10, 50 may include a combination of carbon fiber heaters and an alternative heater (e.g., a conductive ink heater 300 (FIG. 5), phase change material 1200 (FIG. 15), and/or a thermoelectric cooler/heater device 1005 (FIG. 12),), as described below.

FIG. 5 illustrates a conductive ink heater 300 that may be implemented as a heater array (e.g., heater array 26, 52) in a heated garment (e.g., heated jacket 10, 50). Conductive ink heaters 300 provide an even spread of heat across the surface of the heater due to a uniform emission of heat across the heater. The conductive ink heater 300 may include two different types of ink. For example, a first ink may provide power, while a second ink may provide resistance and, thereby, heat. In some embodiments, the first ink may be silver, and the second ink may be carbon. In other embodiments, other suitable inks may also or alternatively be used. When dried and cured, the inks of the conductive ink heater 300 are relatively flexible. The conductive ink heater 300 is also waterproof. In some embodiments, conductive ink heaters 300 may be paired with phase change material 1200 (FIG. 15). In some embodiments, conductive ink heaters 300 may be paired with a feedback loop temperature monitoring to maintain a temperature of the heated garment.

The conductive ink heater 300 includes multiple layers. The first layer 305 may be a fabric layer. For example, the fabric layer may be any suitable fabric or substrate material, such as nylon, polyester, cotton, blends, and the like. The second layer 310 may be a flexible film layer that is stretchable. For example, the flexible film layer may be a thermoplastic polyurethane (TPU) layer with a hot-melt adhesive. The third layer 315 may be a conductive silver trace and busbar system. The fourth layer 320 may be resistive carbon element. The fifth layer 325 may be a cover film. For example, the cover film may be plain or may be customized with printed graphics. The cover film may also inhibit a user from making direct contact with the conductive ink. In other embodiments, the conductive ink heater 300 may include fewer layers. In still other embodiments, the conductive ink heater 300 may include additional layers.

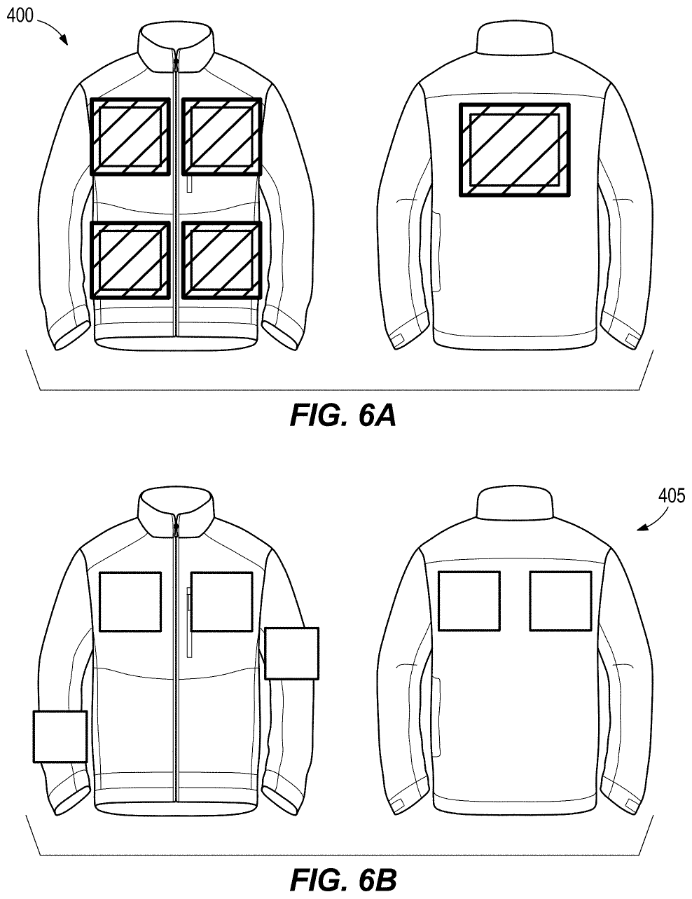

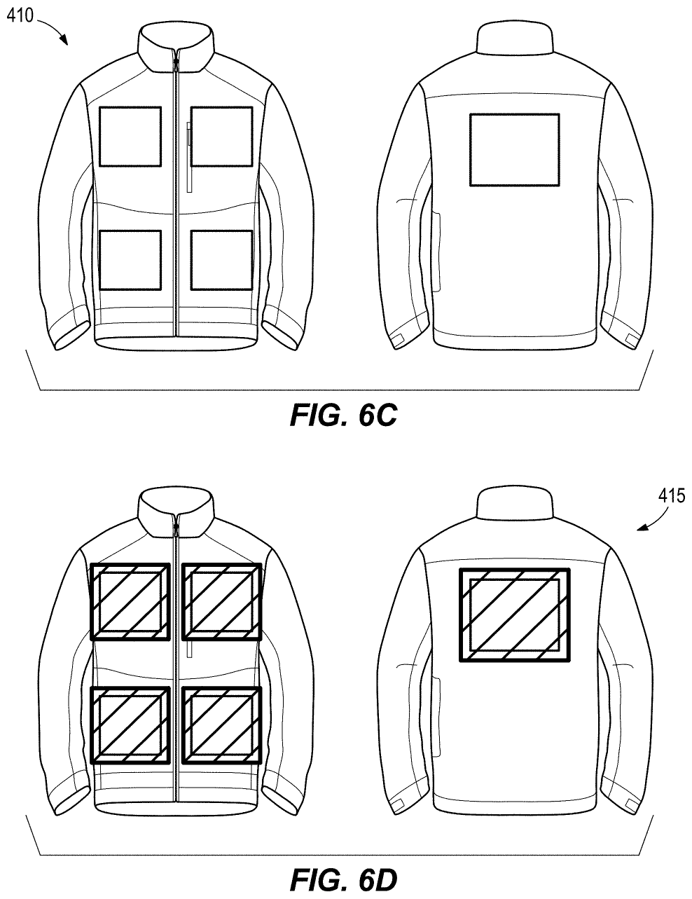

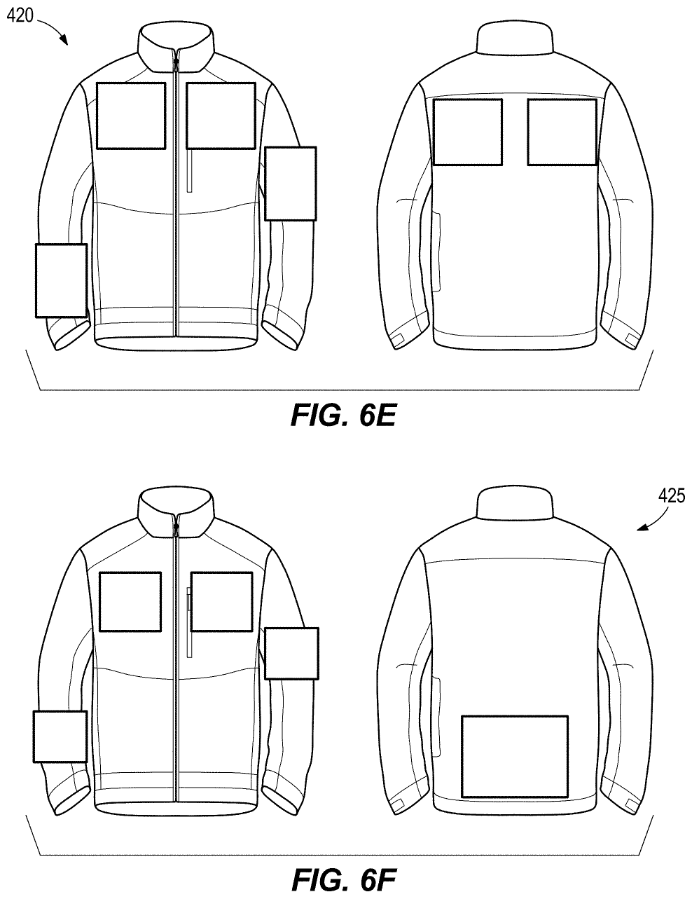

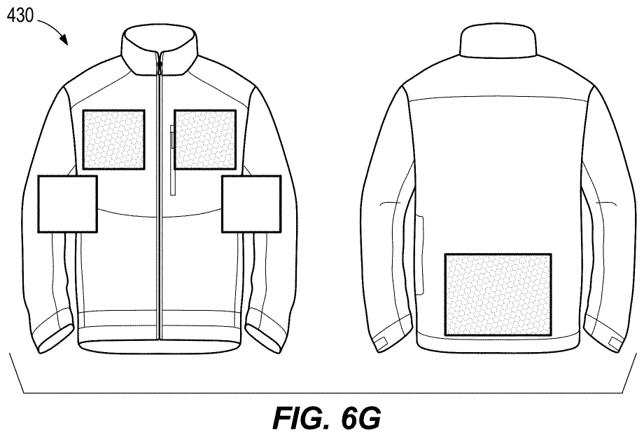

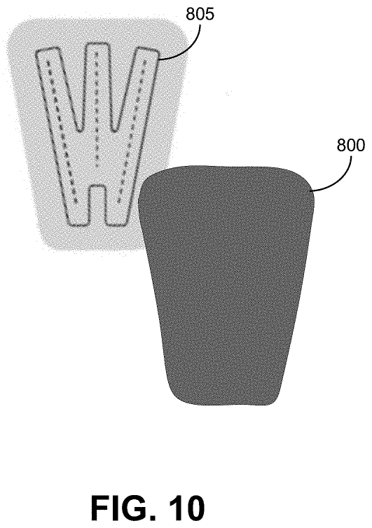

FIGS. 6A-6G illustrate heater array arrangements in a heated garment (e.g., heated jacket 10, 50). The heater array arrangements may include a combination of carbon fiber heaters 200, 210, 220, 230, 240, 250, 260, conductive ink heaters 300, and phase change material 1200 (FIG. 15). In some embodiments, the heater array arrangements may include a heat shield 800 (FIG. 10). The heater array arrangements will be described with reference to the heated jacket 10 of FIG. 1. In general, carbon fiber heaters may be implemented at locations in the heated jacket 10 that experience less movement (e.g., the chest area 20 and the back) and conductive ink heaters may be implemented in areas with more movement (e.g., the sleeves 14 and armpit areas).

FIG. 6A illustrates a first heater array arrangement 400 including carbon fiber heaters 200, 210, 220, 230, 240, 250, 260 located on the left portion 28 of the chest area 20, the right portion 30 of the chest area 20, the left portion of the torso body 12, the right portion 30 of the torso body 12, and an upper area of the back torso body. In some embodiments, the first heater array arrangement 400 includes heaters carbon fiber heaters 200, 210, 220, 230, 240, 250, 260. Alternatively, or additionally, in some embodiments, the first heater array arrangement 400 includes conductive ink heaters 300. In some embodiments, the first heater array arrangement 400 includes heat shields 800 sewn between the carbon fiber heaters 200, 210, 220, 230, 240, 250, 260 and/or the conductive ink heaters 300 and the exterior of the heated jacket 10.

FIG. 6B illustrates a second heater array arrangement 405 including carbon fiber heaters 200, 210, 220, 230, 240, 250, 260 located on the left portion 28 of the chest area 20, the right portion 30 of the chest area 20, the arm area on left side, the arm area on the right side, a left upper area of the back torso body, and a right upper area of the back torso body. In some embodiments, the heaters on the arm areas may be conductive in heaters 300.

FIG. 6C illustrates a third heater array arrangement 410 including carbon fiber heaters 200, 210, 220, 230, 240, 250, 260 located on the left portion 28 of the chest area 20, the right portion 30 of the chest area 20, the left portion of the torso body 12, the right portion 30 of the torso body 12, and an upper area of the back torso body. In some embodiments, the carbon fiber heaters of the third heater array arrangement 410 are 25% larger than the carbon fiber heaters of the first heater array arrangement 400.

FIG. 6D illustrates a fourth heater array arrangement 415 including carbon fiber heaters 200, 210, 220, 230, 240, 250, 260 located on the left portion 28 of the chest area 20, the right portion 30 of the chest area 20, the left portion of the torso body 12, the right portion 30 of the torso body 12, and an upper area of the back torso body. In some embodiments, the first heater array arrangement 400 includes heat shields sewn between the carbon fiber heaters 200, 210, 220, 230, 240, 250, 260 and the exterior of the heated jacket 10. In some embodiments, the carbon fiber heaters of the third heater array arrangement 410 are 25% larger than the carbon fiber heaters of the first heater array arrangement 400.

FIG. 6E illustrates a fifth heater array arrangement 420 including carbon fiber heaters 200, 210, 220, 230, 240, 250, 260 located on the left portion 28 of the chest area 20, the right portion 30 of the chest area 20, the arm area 14 on the left side, the arm area 14 on the right side, a left upper area of the back torso body, and a right upper area of the back torso body. In some embodiments, the carbon fiber heaters of the fifth heater array arrangement 420 are 25% larger than the carbon fiber heaters of the second heater array arrangement 405. In some embodiments, the heaters on the arm areas may be conductive ink heaters 300.

FIG. 6F illustrates a sixth heater array arrangement 425 including conductive ink heaters 300 located on the left portion 28 of the chest area 20, the right portion 30 of the chest area 20, the arm area 14 on the left side, the arm 14 on the right side, and a lower area of the back torso body.

FIG. 6G illustrates a seventh heater array arrangement 430 including conductive ink heaters 300 located on a left and right armpit area (e.g., where the arms 14 meet the chest area 20 of the heated jacket 10). The seventh heater array arrangement 430 includes carbon fiber heaters 200, 210, 220, 230, 240, 250, 260 located on the left portion 28 of the chest area 20, the right portion 30 of the chest area 20, and an upper area of the back torso body. In some embodiments, the garment body may only include conductive ink heaters 300 in one or both of the armpit areas.

The heater array arrangements 400, 405, 410, 415, 420, 425, 430 are in no way limiting and may include conductive ink heaters 300 located at various other locations on the heated jacket 10.

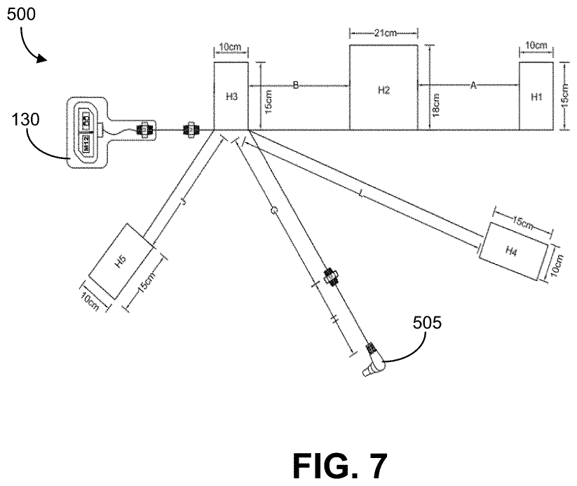

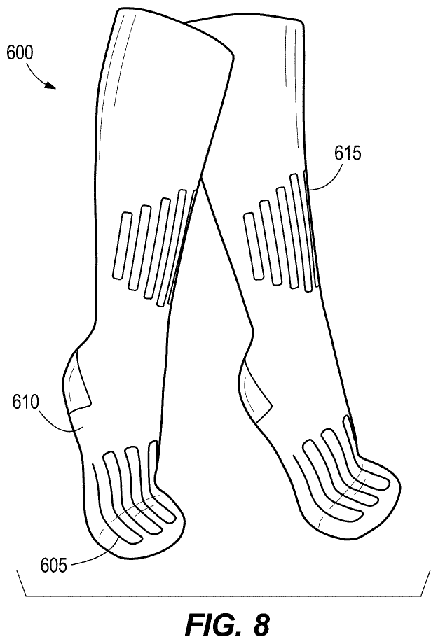

FIG. 7 illustrates one example of a conductive ink heater 500. In some embodiments, the conductive ink heater 500 includes a first heater array H2 and four second heater arrays H1, H3, H4, H5. The first heater array H2 and second heater arrays H1, H3, H4, H5 are connected to one another via wires and receive power from the battery pack 130. The first heater array H2 may be 18 cm long, 21 cm wide, output 12 volts (V), and provide 6 watts (W) of power. The second heater arrays H1, H3, H4, H5 may be 15 cm long, 10 cm wide, output 12V and provide 2.8 W. The heater arrays of the conductive ink heater design 500 are separated by various segments of wire as evidenced by segments A, B, J, L. The conductive ink heater design 500 includes a connection port 505 connected to the heater arrays via segments G, H. In other embodiments, the conductive ink heater 500 may include fewer or more heater arrays. Additionally or alternatively, the heater arrays may have other sizes and/or be powered at other voltages.

FIG. 8 illustrates a heated accessory, such as a pair of heated socks 600. The heated socks 600 includes a conductive ink heater 605 on a foot portion 610. Additionally, or alternatively, in some embodiments, the conductive ink heater 605 may be located on a shin portion 615 of the heated sock 600. Conductive ink heaters 605 in heated socks 600 provide additional comfort to a wearer of the heated socks 600 due to the absence of heating wires.

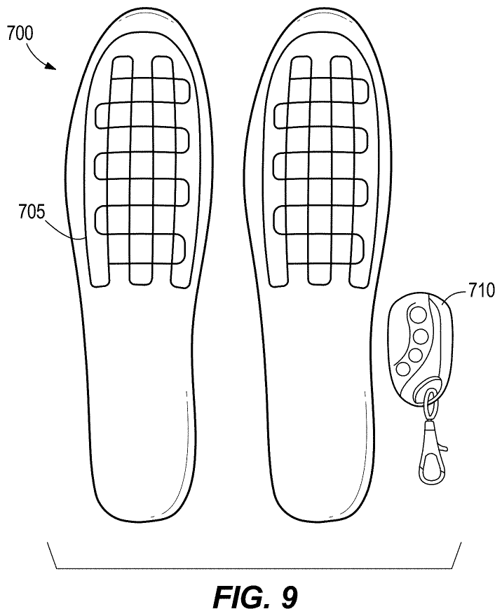

FIG. 9 illustrates a heated accessory, such as a pair of heated shoe liners 700. The heated shoe liners include a conductive ink heater 705 located in a forefoot area of the heated shoe liner 700. Alternatively, or additionally, in some embodiments, the conductive ink heater may be located in a heel area of the heated shoe liner. The conductive ink heater 705 may be controlled via a key fob 710. In some embodiments, the key fob 710 may turn the conductive ink heater 705 ON/OFF and adjust the temperature of the conductive ink heater 705. Alternatively, the conductive ink heater 705 may be controlled by other wireless devices, such as a user's smartphone.

In some embodiments, conductive ink heaters may be implemented in additional heated accessories such as heated beanies, heated gloves, heated sleeves (as part of a jacket or vest, or as a separate garment), heated undergarments, and heated base layers.

FIG. 10 illustrates a heat shield 800 for increasing heat retention in heated garments (e.g., heated jackets 10, 50). The heat shield 800 may be approximately the same size and shape of an adjacent heater array 805. The heat shield 800 may alternatively be larger than the heater array 805, or may have a different shape than the heater array 805. For example, the heat shield 800 may be a second area, larger than a first area denoted by the carbon fiber wiring boundary. In some embodiments, the heat shield 800 may be positioned between the heater array 805 and an exterior of the heated garment. In some embodiments, there may be two heat shields 800 layered on top of one another. In some embodiments, the heat shield 800 may be a highly insulative fabric. The heat shield 800 reflects thermal energy back to the interior of a heated garment increasing heat retention of the heated garment and, thus, increasing the warmth of the heated garment. In some embodiments, the increased heat retention has a proportional effect on an increased runtime of the heater array 805. A heat shield may be positioned adjacent each heater array in a garment or may only be positioned adjacent some of the heater arrays in a garment. In addition, a single heat shield may extend across and cover multiple heater arrays in a garment. Alternatively, multiple heat shields may be used to cover a single heater array, or a heat shield may be used to cover only a portion of a heater array. In some embodiments, an insulation layer may be provided between the heater array 805 and an exterior of the heated garment. In some embodiments, the insulation layer may be provided in addition to the heat shield 800. In some embodiments, multiple layers of the insulation layer may be provided in the heated garment to increase a heat retention of the heated garment.

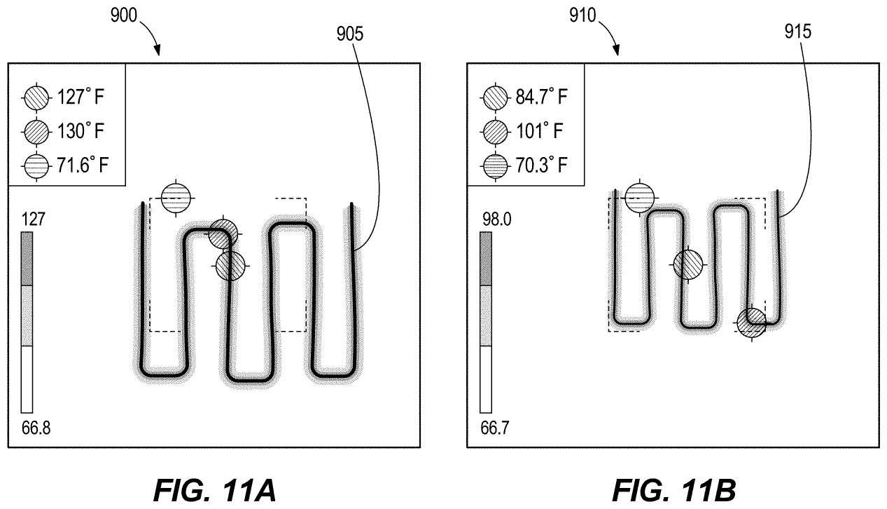

FIG. 11A illustrates a first infrared photograph 900 that captures a heater array 905 without the presence of a heat shield (e.g., heat shield 800) between the heater array 905 and the exterior of the heated garment (e.g., heated jackets 10, 50). As evidenced by the first infrared graph 900, the range of temperatures captured is 66.8-127° F.

FIG. 11B illustrates a second infrared photograph 900 that captures a heater array (e.g., heater array 805) and heat shield (e.g., heat shield 800) combination 915. As evidenced by the second infrared graph 910, the range of temperatures captured is 66.8-98° F. Accordingly, the heater array and heat shield combination 915 lowers the amount of heat that escapes the heated garment.

FIG. 12 is a back side view of a heated garment 1000. The heated garment 1000 includes thermoelectric cooler/heater (also referred to as “Peltier coolers/heaters) devices 1005 located on the back torso portion 1010. In some embodiments, thermoelectric cooler/heater devices may cool a wearer of the heated garment 1000 as well as heat a wearer of the heated garment 1000. Thermoelectric cooler/heater devices 1005 will be explained in detail below with respect to FIG. 13.

The illustrated heated garment 1000 includes six thermoelectric cooler/heater devices 1005 spaced apart on the heated garment. The first thermoelectric cooler/heater device 1005 is located at a left, upper back portion of the heated garment 1000. The second thermoelectric cooler/heater device 1005 is located at a right, upper back portion of the heated garment 1000. The third thermoelectric cooler/heater device 1005 is located at a left, lower back portion of the heated garment 1000. The fourth thermoelectric cooler/heater device 1005 is located at a right, lower back portion of the heated garment 1000. The fifth thermoelectric cooler/heater device 1005 is located at a left, middle back portion of the heated garment 1000. The sixth thermoelectric cooler/heater device 1005 is located at a right, middle back portion of the heated garment 1000. In other embodiments, the thermoelectric cooler/heater devices 1005 may also or alternatively be located elsewhere on the heated garment 1000, such as on the front, sleeves, shoulders, and/or armpits of the heated garment 1000. In some embodiments, the heated garment 1000 may only a subset of the thermoelectric cooler/heater devices 1005 described above.

On example of the thermoelectric cooler/heater device 1005 is illustrated in FIG. 13. The illustrated thermoelectric cooler/heater device 1005 is a heat pump which transfers heat from a first side 1015 to a second side 1020 based on a direction of an applied current. For example, the first side 1015 may be adjacent skin of a wearer of the heated garment 1000 and may pull body heat to the second side 1020 to cool the wearer of the heated garment 1000. Alternatively, the thermoelectric cooler/heater device 1005 may pull heat from the second side 1020 toward the first side 1015 to heat a user. In some configurations, a controller coupled to the thermoelectric cooler/heater device 1005 may alternate in which direction the thermoelectric cooler/heater device 1005 pulls heat, depending on whether a user wants to be cooled or warmed. IN other embodiments, the orientation of the thermoelectric cooler/heater device 1005 may be physically reversed on the garment depending on whether a user wants to be cooled or warmed. In some embodiments, the thermoelectric cooler/heater device 1005 includes a Peltier semiconductor device.

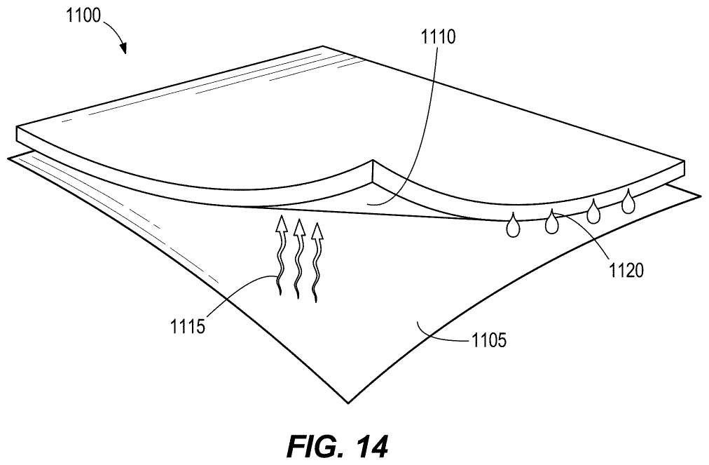

FIG. 14 illustrates a heated fabric 1100 for improving heat retention in heated garments (e.g., heated jackets 10, 50). In some embodiments, the heated fabric 1100 may be located on an interior of the heated jacket 10, 50 such that the heated fabric 1100 contacts or is near skin 1105 of a wearer of the heated jacket 10, 50. The skin 1105 transfers body heat 1115 to an insulation layer 1110 of the heated fabric 1100. The insulation layer 1100 may also provide absorption and moisture control when encountering perspiration 1120 from the skin 1105. In some embodiments, the heated fabric 1100 may be a charcoal color that absorbs heat and delays heat transfer to outside the heated jacket 10, 50. In some scenarios, the heated fabric 1100 may increase heat retention by 18° F.

FIG. 15 illustrates a phase change material 1200 for improving heat retention in heated garments (e.g., heated jackets 10, 50). The phase change material 1200 may be implemented for heating and cooling by maintaining a comfortable body temperature range of a wearer of the heated jacket 10, 50. A wearer of the heated jacket 10, 50 may feel increased warmth when the phase change material 1200 is integrated into the fabric of the heated jacket 10, 50. For example, the phase change material 1200 may be included in the lining of the heated jacket 10, 50.

In some embodiments, the phase change material 1200 may be a dip that is used to treat fabric. For example, the phase change material 1200 may be a microencapsulated wax that is applied to an elastic material used in heated base layers and a taffeta material used in heated jackets. The phase change material 1200 absorbs and releases thermal energy to maintain a regulated temperature range. As shown in FIG. 15, the phase change material 1200 is initially in a solid state 1205. When a body temperature increases, the phase change material 1200 melts and absorbs heat energy in a second state 1210. When a threshold temperature is met, the phase change material 1200 is in a liquid state 1215. For example, in the liquid state 1215, the phase change material 1200 stores thermal energy. When the body temperature decreases and/or the phase change material 1200 is exposed to cooler temperatures (e.g., a temperature below a threshold value), the phase change material 1200 solidifies and releases heat energy in a fourth state 1220. For example, the phase change material 1200 releases the stored thermal energy to increase warmth.

Utilizing phase change material 1200 in a heated jacket 10, 50 decreases the amount of heat needed from the heater array 26, 52, thus, increasing the runtime and efficiency of the heater array 26, 52. The phase change material supplies an appropriate amount of heat to a wearer of the heated jacket 10, 50 to create an ideal temperature and environment.

Thus, embodiments described herein provide, among other things, carbon fiber heating element designs, conductive ink heating elements, phase change material, heat shields, and heating fabric for increased heat retention, and a thermoelectric cooler/heater device. Although the embodiments have been described with reference to particular configurations, variations and modifications exist within the scope and spirit of the invention. For example, as noted above, any of the heaters described above may be used in combination with each other and in different locations on the heated garments.

Various features and advantages are set forth in the following claims.

1. A heated garment comprising:
a garment body;
a heater array supported by the garment body, the heater array including a heating wire that forms a closed loop, the closed loop defining a shape having a plurality of cantilevered fingers; and
a power supply interface configured to couple to a power source that provides power to the heater array.

2. The heated garment of claim 1, wherein the closed loop has a first cantilevered finger and a second cantilevered finger that is parallel to the first cantilevered finger.

3. The heated garment of claim 1, wherein the closed loop has a first cantilevered finger and a second cantilevered finger that is fanned out along a central axis from the first cantilevered finger.

4. The heated garment of claim 1, wherein the closed loop has a first cantilevered finger, a second cantilevered finger, and a third cantilevered finger.

5. The heated garment of claim 1, wherein the closed loop has a first cantilevered finger, a second cantilevered finger, a third cantilevered finger, and a fourth cantilevered finger, and wherein the third and fourth cantilevered fingers fanned out along a central axis from the first and second cantilevered fingers.

6. The heated garment of claim 1 further comprising:
a heat shield supported by the garment body, the heat shield provided between the heating wire and an exterior of the garment body.

7. The heated garment of claim 1, wherein the heating wire is a carbon fiber heater.

8. The heated garment of claim 1, wherein the heater array further includes a second heating wire, a third heating wire, and a fourth heating wire.

9. A heated garment comprising:
a garment body;
a heater array supported by the garment body, the heater array including a stretchable fabric layer and a heating wire positioned on the stretchable fabric layer; and
a power supply interface configured to couple to a power source that provides power to the heater array.

10. The heated garment of claim 9, wherein the stretchable fabric layer includes a cut adjacent to the heating wire.

11. The heated garment of claim 9, wherein the stretchable fabric layer is comprised of a stretchable fabric.

12. The heated garment of claim 9, wherein the heating wire is a carbon fiber heater.

13. The heated garment of claim 9, wherein the heater array further includes a second heating wire, a third heating wire, and a fourth heating wire positioned on the stretchable fabric layer.

14. A heated garment comprising:
a garment body;
a heater array supported by the garment body, the heater array including a stretchable fabric layer and a heating wire positioned on the stretchable fabric layer, the heating wire forming a closed loop; and
a power supply interface configured to couple to a battery pack that provides power to the heater array.

15. The heated garment of claim 14, wherein the stretchable fabric layer includes a cut positioned within the closed loop.

16. The heated garment of claim 14, wherein the closed loop has a first cantilevered finger and a second cantilevered finger that is parallel to the first cantilevered finger.

17. The heated garment of claim 16, wherein the stretchable fabric layer includes a cut between the first cantilevered finger and the second cantilevered finger.

18. The heated garment of claim 14, wherein the stretchable fabric layer includes a first cut positioned within the closed loop and a second cut positioned outside the closed loop.

19. The heated garment of claim 14, wherein the closed loop has a first cantilevered finger and a second cantilevered finger that is fanned out along a central axis from the first cantilevered finger.

20. The heated garment of claim 14, wherein the heating wire is a carbon fiber heater.

21.-60. (canceled)
